(19) United States
(12) Patent Application Publication
(10) Pub. No.: US 2006/0085656 A1
(43) Pub. Date: Apr. 20, 2006

(54) Voltage ID conversion system for programmable power supplies

(76) Inventor: Jonathan Betts-LaCroix, Chatsworth, CA (US)

Correspondence Address: ROBERT PLOTKIN, PC, 91 MAIN STREET, SUITE 204, CONCORD, MA, 01742-2527, US

(21) Appl. No.: 11/248,987

(22) Filed: Oct. 12, 2005

Related U.S. Application Data
(60) Provisional application No. 60/618,084, filed on Oct. 12, 2004.

(51) Int. Cl. G06F 1/26

(52) U.S. Cl. 713/300

(57) ABSTRACT

Techniques are disclosed for converting voltage identification (VID) codes into analog signals suitable for input to analog-programmable power supplies. An encoding scheme is used in which each VID includes a plurality of fields (e.g., bits). Each field is associated with a particular voltage level to be output by an analog-programmable power supply. A VID code is formed for encoding a particular desired output voltage level by assigning a first value (e.g., logical 1) to the VID field associated with the desired output voltage level, and by assigning a second value (e.g., logical 0) to the remaining VID fields. The VID code is provided to VID conversion circuitry which converts the VID code into an analog signal that may be provided to the analog-programmable power supply to produce the desired output voltage level. The VID conversion circuitry may include a single switch (e.g., FET) and resistor for each VID field.

### CROSS REFERENCE TO RELATED APPLICATIONS

This application claims priority from U.S. Provisional Patent Application Ser. No. 60/618,084, filed on Oct. 12, 2004, entitled “Voltage ID Conversion System for Programmable Power Supplies,” which is hereby incorporated by reference.

### BACKGROUND

1. Field of the Invention

The present invention relates to power supplies for microprocessors and, more particularly, to techniques for modulating the voltage level output by programmable power supplies.

2. Related Art

Portable computing devices, such as laptop computers, personal digital assistants (PDAs), and tablet computers typically run on battery power. The batteries in such devices typically fully discharge after several hours of use. When the battery in a portable computing device has fully discharged, it becomes necessary to recharge the battery, replace the battery with a fully-charged battery, or plug the device directly into a power outlet in order to continue using the device. Each of these options has various disadvantages.

Fully recharging a battery requires inserting the battery into a charger, plugging the charger into a power outlet, and waiting up to several hours. Recharging the battery in this way may be inconvenient or impossible for any of a variety of reasons. For example, the user may not have access to a battery charger or to a power outlet. Furthermore, the user may not have time to wait for the battery to recharge. Even if the user has access to a battery charger and a power outlet and has time to wait for the battery to recharge, it may be inconvenient for the user to carry a battery charger with him, to access a power outlet, and to wait for the battery to recharge.

Replacing the battery with a fully-charged battery may be inconvenient or impossible for any of a variety of reasons. For example, the user may not have access to a fully-charged battery or may find it inconvenient to charge several batteries before traveling and to carry them with her on each trip. In addition, purchasing additional batteries increases the total cost of owning the corresponding portable computing device.

Finally, it may be inconvenient or impossible for the user to power the portable computing device by plugging it directly into an outlet. For example, the user may be in a location (such as an airplane or automobile) in which a power outlet is not available. Furthermore, the user may find it inconvenient to carry a power cord and to find a power outlet, relocate to the site of a power outlet, and remain at the site of the power outlet to continue using the portable computing device.

For these and other reasons it is highly desirable to enable portable computing devices to operate on a single battery charge for as long as possible. Portable computing device designers have attempted to increase the amount of time that such devices can run on a single battery charge both by improving the designs of the batteries themselves and by improving the designs of portable computing devices to make them capable of using battery power more efficiently.

One way in which portable computing devices have been made more energy efficient is by enabling the power provided to their central processing units (CPUs) to be varied. In particular, the CPU in a portable computing device may be capable of automatically entering a “sleep” mode when the device has been idle for a certain minimum period of time. While in sleep mode, the CPU requires and is provided with a significantly-reduced amount of power. The same CPU may be capable of operating in additional power-saving modes requiring various intermediate levels of power. In this way the CPU avoids drawing unnecessary power, thereby increasing the amount of time until the device's battery needs to be recharged.

Referring to FIG. 1, a prior art system 100 is shown including a CPU 102 and a power supply 104 for supplying power to the CPU 102. The CPU 102 specifies the voltage to be output by the power supply 104 by transmitting a voltage ID (VID) code to the power supply 104 over a parallel bus 108, referred to herein as a “VID bus.” The power supply 104 translates the VID into a particular voltage level and outputs the voltage over a power bus 114. Although the CPU 102 draws power from the power bus 114, the connection between the CPU 102 and power bus 114 is not shown in FIG. 1 for ease of illustration.

More specifically, the CPU 102 outputs a 5-bit VID code on outputs 106a-e and transmits the code as a VID signal over bus lines 110a-e to inputs 112a-e of the power supply 104. The power supply 104 includes a lookup table or other means for mapping the particular VID code transmitted by the CPU 102 into a particular voltage level to output on the power bus 114. Although the mapping of VID codes to voltage levels varies from power supply to power supply, such mappings typically specify a list of VID codes in ascending numerical order and a corresponding set of output voltages, which typically form a monotonic voltage ramp or set of ramps in different scales.

In some cases it may be advantageous to use a power supply that does not accept VID codes as inputs. For example, in some cases there may be no commercially-available power supply that accepts VID codes and that satisfies particular design requirements (e.g., maximum volume, high power conversion efficiency). Such alternative power supplies typically require as input an analog signal that corresponds to the desired output voltage.

For example, referring to FIG. 2, an example of a prior art system 200 is shown including the CPU 102 and an analog-programmable power supply 214 that includes an analog input 216 for receiving an analog signal specifying the output voltage to provide on power bus 114. As used herein, the term “analog-programmable power supply” refers generally to any power supply that uses an analog input signal to select an output voltage level.

As in the system 100 of FIG. 1, the CPU 102 in FIG. 2 outputs a VID code at outputs 106a-e. Unlike system 100, however, system 200 includes a PAL 202 (programmable array logic) that receives the VID signal at inputs 204a-e. The PAL 202 translates the VID code output by the CPU 102 into a digital signal on outputs 206a-h. A digital-to-analog (D/A) converter 208 receives this digital signal at inputs 210a-h and converts the digital signal into an analog signal on output 212. This analog signal is provided to input 216 of power supply 214, which outputs an appropriate corresponding voltage level in response. Although the PAL 202 may not be needed in all cases, the system 200 must include at least the D/A converter 208 to convert the VID code (or a digital signal derived from it) into an analog signal suitable for input to the power supply 214.

Although the PAL 202 and D/A converter 208 perform the desired function, such added circuitry increases the total volume and manufacturing cost of the system 200, in some cases to an unacceptable degree. Volume and cost considerations are becoming increasingly significant as the size of portable computing devices decreases and pricing pressures increase.

What is needed, therefore, are improved techniques for converting VID codes into analog signals suitable for input to analog-programmable power supplies.

### SUMMARY

Techniques are disclosed for converting voltage identification (VID) codes into analog signals suitable for input to analog-programmable power supplies. An encoding scheme is used in which each VID includes a plurality of fields (e.g., bits). Each field is associated with a particular voltage level to be output by an analog-programmable power supply. A VID code is formed for encoding a particular desired output voltage level by assigning a first value (e.g., logical 1) to the VID field associated with the desired output voltage level, and by assigning a second value (e.g., logical 0) to the remaining VID fields. The VID code is provided to VID conversion circuitry which converts the VID code into an analog signal that may be provided to the analog-programmable power supply to produce the desired output voltage level. The VID conversion circuitry may include a single switch (e.g., FET) and resistor for each VID field.

For example, in one aspect of the present invention, a method is provided which includes steps of: (A) generating a digital voltage identification (VID) signal including a plurality of fields by performing steps of: (A)(1) assigning a first value to a first one of the plurality of fields, the first one of the plurality of fields corresponding to a desired output voltage; and (A)(2) assigning a second value to at least one other one of the plurality of fields; and (B) converting the VID signal into an analog signal suitable for input to an analog-programmable power supply.

In another aspect of the present invention, a system is provided which includes generation means for generating a digital voltage identification (VID) signal including a plurality of fields. The generation means includes means for assigning a first value to a first one of the plurality of fields, the first one of the plurality of fields corresponding to a desired output voltage; and means for assigning a second value to at least one other one of the plurality of fields. The system further includes conversion means for converting the VID signal into an analog signal suitable for input to an analog-programmable power supply.

In yet another aspect of the present invention, a system is provided which includes: a parallel bus includes a plurality of bus lines; transmission means for transmitting a plurality of fields of a digital voltage identification (VID) signal over corresponding ones of the plurality of bus lines, wherein the plurality of fields includes a first field having a first value and at least one second field having a second value that differs from the first value; a plurality of FETs coupled to the plurality of bus lines; a plurality of resistors, each of which is coupled between a corresponding one of the plurality of FETs and an intermediate node; a power source; a resistor coupled between the power source and the intermediate node; and an analog-programmable power supply having an analog input coupled to the intermediate node.

Other features and advantages of various aspects and embodiments of the present invention will become apparent from the following description and from the claims.

### BRIEF DESCRIPTION OF THE DRAWINGS

FIG. 1 is a diagram of a prior art system for controlling the power output by a power supply using a digital VID signal;

FIG. 2 is a diagram of a prior art system for controlling the power output by an analog-programmable power supply using a digital VID signal that is converted into an analog signal using a PAL and a D/A converter;

FIG. 3 is a diagram of a system for controlling the power output by an analog-programmable power supply according to one embodiment of the present invention;

FIG. 4 is a diagram of a voltage ID code table according to one embodiment of the present invention;

FIG. 5A is a flowchart of a method for producing a desired output voltage for powering a microprocessor based on a VID signal according to one embodiment of the present invention;

FIG. 5B is a flowchart of a method for producing an analog signal suitable for input to an analog-programmable power supply using the system of FIG. 3 according to one embodiment of the present invention; and

FIG. 6 is a diagram of a system for controlling the power output by an analog-programmable power supply according to another embodiment of the present invention.

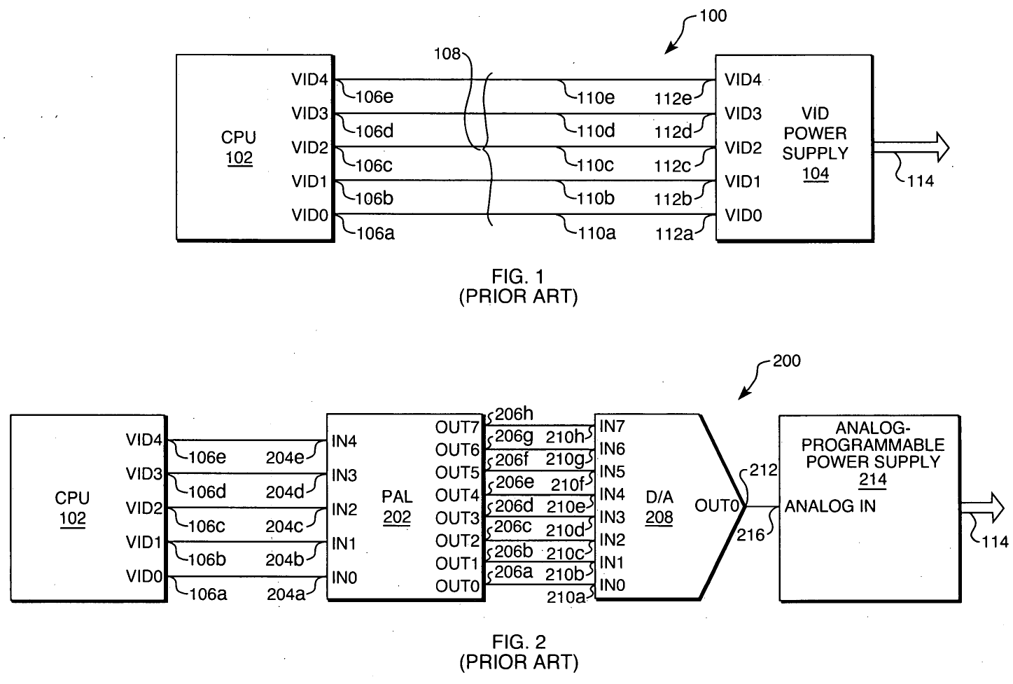

### DETAILED DESCRIPTION

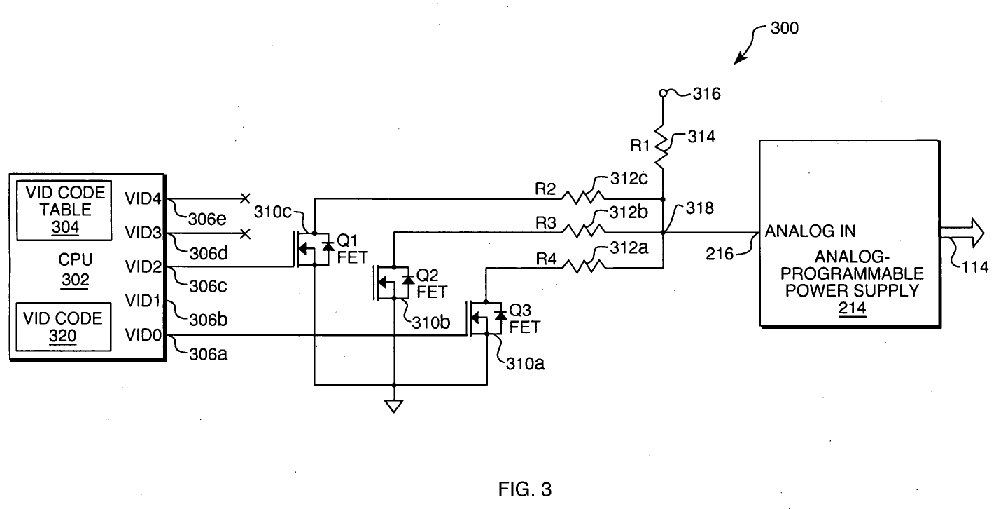

Referring to FIG. 3, a schematic diagram is shown of a system 300 for converting a digital VID signal into an analog signal suitable for input to the analog-programmable power supply 214 according to one embodiment of the present invention. The system 300 includes a CPU 302 or other microprocessor. The CPU 302 may, for example, be the Crusoe™ model TM5800 processor, available from Transmeta Corporation of Santa Clara, Calif. The CPU 302 includes a VID code table 304 that is modifiable by the designer of the system 300 to specify any desired set of digital VID codes and any desired mapping between VID codes and desired power supply output voltages. The CPU 302 generates and stores a VID code 320 that corresponds to the desired voltage level to be output by the power supply 214.

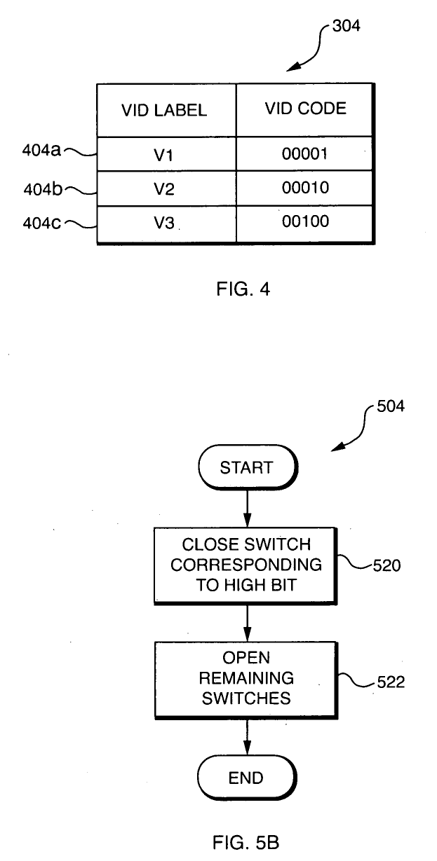

For example, referring to FIG. 4, the contents of the VID code table 304 are shown according to one embodiment of the present invention. The VID code table 304 includes a voltage label column 402a and a voltage ID (VID) code column 402b. The example VID code table 304 shown in FIG. 4 includes three records 404a-c, each of which specifies a mapping between a particular voltage label and a corresponding VID code. More specifically, record 404a specifies that the voltage label V1 corresponds to the VID code 00001; record 404b specifies that the voltage label V2 corresponds to the VID code 00010; and record 404c specifies that the voltage label V3 corresponds to the VID code 00100.

The voltage labels in column 402a may, for example, correspond to states of decreasing power consumption. For example, the label V1 may correspond to the full-power state of CPU 302, the label V2 may correspond to a partial-power state of CPU 302, and the label V3 may correspond to a standby state of CPU 302. These are merely examples, however, and the values in the voltage label column 402a may have any meanings. Furthermore, although the VID codes in VID code column 402b are in ascending numerical order in the VID code table 304 shown in FIG. 4, this is not a requirement of the present invention.

According to the label-code mapping scheme shown in FIG. 4, each bit position in the VID code 320 is associated with a particular output voltage level. In the example shown in FIG. 4, bit position 0 (the least-significant bit) is associated with voltage level V1, bit position 1 is associated with voltage level V2, and bit position 2 is associated with voltage level V3. Bit positions 3-4 are unused.

According to this scheme, a VID code specifying a particular output voltage level may be formed by: (1) identifying the bit position associated with the output voltage level; (2) storing a first value (e.g., logical 1) in the identified bit position of the VID code; and (3) storing a second value (e.g., logical 0) in the remaining bit positions. The VID code table 304 may be generated by generating VID codes in this manner for each possible output voltage level, associating each such VID code with a VID label, and storing records in the VID code table 304 indicating the chosen associations between VID labels and VID codes.

It should be appreciated that any value may be stored in unused bit positions of the VID code 320, such as bit positions 3-4 in the example shown in FIG. 4. Furthermore, it should be appreciated that although each field in the VID codes shown in FIG. 4 includes exactly one bit, VID code fields may include more than one bit each. If n is the number of fields (e.g., bits) in the VID code 320, the encoding scheme shown in FIG. 4 is capable of specifying up to n distinct voltage levels.

Note that the label column 402a in the table 304 is not required. Alternatively, for example, the table may include only the VID code column 402b. Records 404a-c may be stored at distinct memory addresses and the addresses may serve the same function as the label column 402a (i.e., to provide a mapping between output voltages and VID codes).

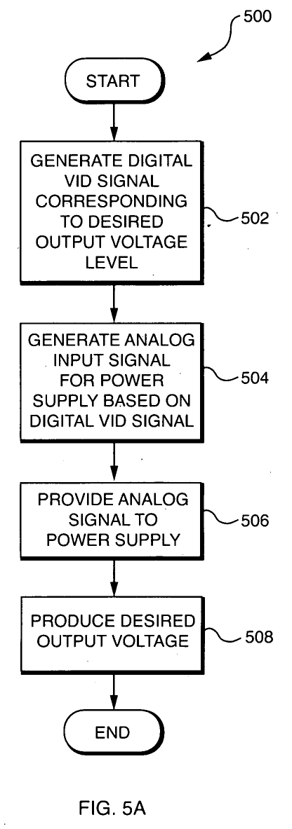

Referring to FIG. 5A, a flowchart is shown of a method 500 that may be used in the system 300 to cause the power supply 214 to produce a desired output voltage level on the power bus 114. Assume for purposes of example that the VID code table 304 is as shown in FIG. 4. Also assume for purposes of example that it is desired to produce the voltage corresponding to voltage label V2.

The method 500 generates a digital voltage ID signal corresponding to the desired output voltage level (step 502). In particular, the CPU 302 may generate and transmit, on lines 306a-e, a digital VID signal having a high logical value at the bit position associated with the desired output voltage level and having a low logical value at the remaining bit positions. In the present example, the CPU 302 may use the VID code table 304 to map the voltage label V2 to the VID code 00010, which has the aforementioned properties.

The method 500 generates an analog input signal suitable for input to the power supply 214 based on the digital VID signal generated in step 502 (step 504). For example, the system 300 shown in FIG. 3 includes three FETs 310a-c coupled to CPU outputs 306a-c, respectively. CPU outputs 306d-e are connected to ground since they output unused VID bits in the present example. The system 300 also includes three resistors 312a-c coupled to FETs 310a-c, respectively. A resistor 314 is connected between power supply voltage Vₘₐₓ 316 and the resistors 312a-c. The resulting output of the circuit formed by the FETs 310a-c and resistors 312a-c and 314 at node 318 is coupled to analog input 216 of power supply 214.

The system 300 converts the digital VID signal output by the CPU 302 into an analog signal at node 318 as follows. FETs 310a-c are closed when the corresponding CPU outputs 306a-c carry a high logical value. Recall that in the present example one and only one of the outputs 306a-c will carry a high logical value at a time. As a result, only one of the FETs 310a-c will be closed at a time. Therefore, current will only flow through one of the resistors 312a-c at a time. Those of ordinary skill in the art will appreciate how to select appropriate resistances for resistors 312a-c and 314 so that the voltage produced at node 318 for each possible VID provides the correct analog input signal to input 216 of the power supply 214 for producing the desired output power voltage. Note that the combination of resistors need not simply implement a discrete D/A converter, but rather may implement a configuration that caters to ease of implementation with a small number of resistors with limited impedance ranges.

Referring to FIG. 5B, step 504 is performed in the system 300 shown in FIG. 3 by closing the switch (e.g., FET 310b) corresponding to the high bit in the VID signal (step 520), and opening the remaining switches (e.g., FETS 310a and 310c) (step 522), thereby producing an analog signal at node 318 suitable for input to the power supply 214.

Returning to FIG. 5A, the method 500 provides the analog signal generated in step 504 to the power supply 216 (step 506), thereby causing the power supply 216 to produce the desired output voltage on the power bus 114 (step 508).

One advantage of the system 300 shown in FIG. 3 is that it uses simpler circuitry than the prior art system 200 shown in FIG. 2 for translating VID codes into analog control signals suitable for controlling the analog power supply 214. As shown in FIG. 3, the system 300 includes only three FETs 310a-c and four resistors 312a-c and 314 for producing the same result as the PAL 202 and D/A converter 208 in the system 200 of FIG. 2. The FETs 310a-c and resistors 312a-c and 314 typically will be much smaller and cost significantly less than the PAL 202 and D/A converter 208, thereby enabling the system 300 to be significantly smaller and cost significantly less to manufacture than the system 200.

It is to be understood that although the invention has been described above in terms of particular embodiments, the foregoing embodiments are provided as illustrative only, and do not limit or define the scope of the invention. Various other embodiments are also within the scope of the claims.

For example, the VID code table 304 may be a custom VID code table 304, i.e., a VID code table in which specific VID codes have been stored for the purpose of enabling VID codes to be generated for use in conjunction with the method 500 illustrated in FIG. 5A. The VID code table 304 may, however, alternatively be a standard (e.g., factory-configured) VID code table that happens to contain VID codes having mutually-exclusive bits or other VID codes that are capable of being used in conjunction with the method 500 illustrated in FIG. 5A. Embodiments of the present invention, in other words, are not limited to use in conjunction with custom VID code tables.

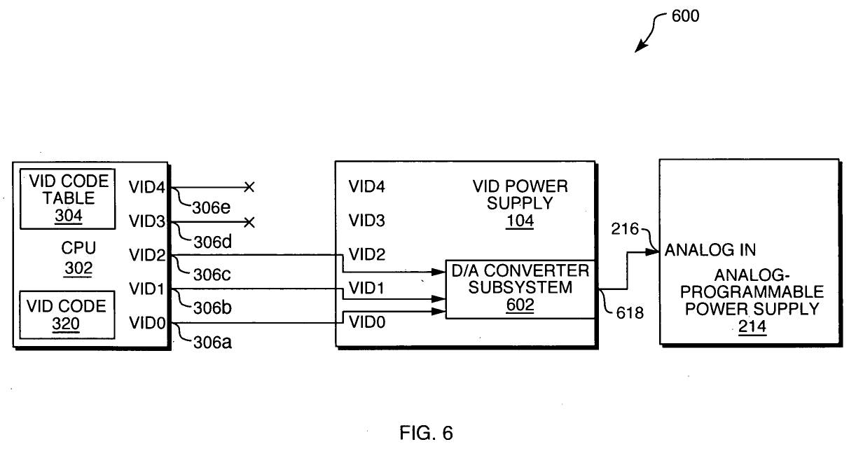

Furthermore, embodiments of the present invention are not limited to using the particular conversion circuitry illustrated in FIG. 3. For example, referring to FIG. 6, a schematic diagram is shown of a another embodiment of a system 600 for converting a digital VID signal into an analog signal suitable for input to the analog-programmable power supply 214. Like the system 300 shown in FIG. 3, the system 600 shown in FIG. 6 includes CPU 302. And, like the system 300 shown in FIG. 3, the system 600 shown in FIG. 6 includes analog-programmable power supply 214.

The system 600 shown in FIG. 6, however, includes VID power supply 104 instead of circuitry 310a-c, 312a-c, 314, 316, and 318. Rather than use the VID power supply 104 to supply power, however, the system 600 of FIG. 6 uses a subset of the VID power supply 104 as a VID translator. More specifically, the system 600 uses an existing D/A converter subsystem 602 (e.g., a controller IC) in the VID power supply 104 to convert the digital VID signals from outputs 306a-c into an analog output signal provided at output signal 618 and received by the analog-programmable power supply 214 at input 216. One benefit of using the existing D/A converter subsystem 602 is that it may be obtained at low cost as part of a commercially-available VID power supply, and eliminates the need to design and manufacture circuitry such as that shown in FIG. 3.

Note that the VID power supply 104 typically includes not only the controller IC that implements the D/A converter subsystem 602, but also a variety of associated large, external components consisting of FETs, inductors, and capacitors. These components may be omitted from the system 600. In other words, the system 600 need not include the entire VID power supply 104 to take advantage of its D/A converter subsystem 602; rather, the D/A converter subsystem 602 may be extracted from the VID power supply 104 and provided within the system 600 without the other components of the VID power supply 104. This has the benefit of reducing the size of the system 600, since the controller IC is relatively small compared to the other components in the VID power supply 104. Furthermore, using the controller IC from the VID power supply 104 has the benefit of implementing a standard VID table, which eliminates the need to implement a custom VID table. Furthermore, using the controller IC from the VID power supply may enable extra features to be used, such as special out-of-band signals and timings that shift the voltage during boot up and during CPU deep sleep states.

What is claimed is:

1. A method comprising steps of:
(A) generating a digital voltage identification (VID) signal including a plurality of fields by performing steps of:
(1) assigning a first value to a first one of the plurality of fields, the first one of the plurality of fields corresponding to a desired output voltage;
(2) assigning a second value to at least one other one of the plurality of fields; and
(B) converting the VID signal into an analog signal suitable for input to an analog-programmable power supply.

2. The method of claim 1, further comprising a step of:
(C) providing the analog signal to the analog-programmable power supply.

3. The method of claim 2, further comprising steps of:
(D) at the analog-programmable power supply, receiving the analog signal; and
(E) at the analog-programmable power supply, outputting the desired output voltage.

4. The method of claim 1, wherein the step (A) comprises a step of generating the digital VID signal by looking up the digital VID signal in a table indexed by a plurality of output voltages.

5. The method of claim 4, further comprising a step of:
(C) prior to steps (A) and (B), storing a plurality of digital VID signals, including the digital voltage identification signal generated in step (A), in the table.

6. The method of claim 1, wherein each of the plurality of fields consists of a single bit.

7. The method of claim 6, wherein the first value comprises a high logical value and wherein the second value comprises a low logical value.

8. The method of claim 1, wherein the step (B) comprises a step of using a digital-to-analog converter subsystem of a VID power supply to convert the VID signal into the analog signal suitable for input to the analog-programmable power supply.

9. A system comprising:
generation means for generating a digital voltage identification (VID) signal including a plurality of fields, the generation means comprising:
means for assigning a first value to a first one of the plurality of fields, the first one of the plurality of fields corresponding to a desired output voltage; and
means for assigning a second value to at least one other one of the plurality of fields; and
conversion means for converting the VID signal into an analog signal suitable for input to an analog-programmable power supply.

10. The system of claim 9, further comprising:
means for providing the analog signal to the analog-programmable power supply.

11. The system of claim 10, further comprising the analog-programmable power supply, and wherein the analog-programmable power supply comprises:
means for receiving the analog signal; and
means for outputting the desired output voltage in response to receiving the analog signal.

12. The system of claim 9, further comprising a central processing unit (CPU) including a VID code table, the VID code table including a plurality of records mapping a plurality of output voltages to a plurality of VID codes, and wherein the generation means comprises:
means for identifying a record in the VID code table corresponding to the desired output voltage;
means for identifying a VID code corresponding to the desired output voltage based on the identified record; and
means for generating the VID signal based on the VID code.

13. The system of claim 12, further comprising:
means for storing a plurality of digital VID signals, including the digital voltage identification signal generated by the generation means, in the table.

14. The system of claim 9, wherein each of the plurality of fields consists of a single bit.

15. The system of claim 14, wherein the first value comprises a high logical value and wherein the second value comprises a low logical value.

16. The system of claim 9, wherein the generation means comprises a microprocessor.

17. The system of claim 16, wherein the microprocessor comprises a VID code table mapping the plurality of output voltages to the plurality of VID codes.

18. The system of claim 9, wherein the conversion means comprises a plurality of FETs and a plurality of corresponding resistors, wherein each of the plurality of FETs is connected in series with the corresponding one of the plurality of resistors, and wherein the generation means comprises a plurality of outputs to output the plurality of fields to corresponding ones of the plurality of FETs.

19. The system of claim 9, wherein the conversion means comprises a digital-to-analog converter subsystem of a VID power supply.

20. A system comprising:
a parallel bus comprising a plurality of bus lines;
transmission means for transmitting a plurality of fields of a digital voltage identification (VID) signal over corresponding ones of the plurality of bus lines, wherein the plurality of fields includes a first field having a first value and at least one second field having a second value that differs from the first value;
a plurality of FETs coupled to the plurality of bus lines;
a plurality of resistors, each of which is coupled between a corresponding one of the plurality of FETs and an intermediate node;
a power source;
a resistor coupled between the power source and the intermediate node; and
an analog-programmable power supply having an analog input coupled to the intermediate node.

21. The system of claim 20, wherein the transmission means comprises a microprocessor.

22. The system of claim 21, wherein the microprocessor includes a VID code table including a plurality of records mapping a plurality of output voltages to a plurality of VID codes.

23. The system of claim 20, wherein each of the plurality of fields consists of a single bit.

24. The system of claim 20, wherein the plurality of resistors comprises no more than five resistors, where the plurality of resistors have corresponding resistances, and wherein the resistance of each of the plurality of resistors is selected to produce an analog signal at the intermediate node corresponding to the digital voltage identification signal.
